(19) United States
(12) Patent Application Publication
(10) Pub. No.: US 2014/0118432 A1
(43) Pub. Date: May 1, 2014

(54) LIQUID EJECTING APPARATUS AND CONTROL METHOD THEREFOR

(71) Applicant: Seiko Epson Corporation, Tokyo (JP)

(72) Inventors: Shinichi YAMAMOTO, Matsumoto-shi (JP); Tomohiro Sayama, Matsumoto-shi (JP); Yoshihiro Watanabe, Shiojiri-shi (JP); Masashi Kamibayashi, Matsumoto-shi (JP); Shinichi Tsubota, Azumino-shi (JP)

(73) Assignee: Seiko Epson Corporation, Tokyo (JP)

(21) Appl. No.: 14/066,937

(22) Filed: Oct. 30, 2013

(30) Foreign Application Priority Data
Nov. 1, 2012 (JP) 2012-241577

(51) Int. Cl. B41J 2/045

(52) U.S. Cl. CPC B41J 2/04541
USPC 347/10

(57) ABSTRACT

A slight oscillation waveform includes a first variation element that varies up to a first electric potential of a first polarity relative to a reference electric potential and thereby causes liquid contained in the pressure chamber to be subjected to a pressure variation, a second variation element which varies up to a second electric potential of a second polarity, which is different from the first polarity, relative to the reference electric potential and thereby causes liquid contained in the pressure chamber to be subjected to a pressure variation, a third variation element which varies up to a third electric potential of the first electric potential and thereby causes liquid contained in the pressure chamber to be subjected to a pressure variation, and a fourth variation element which varies up to the reference electric potential and thereby causes liquid contained in the pressure chamber to be subjected to a pressure variation.

### BACKGROUND

1. Technical Field

The present invention relates to a liquid ejecting apparatus, such as an ink jet recording apparatus, as well as a control method therefor, and in particular, it relates to a liquid ejecting apparatus employing a configuration which causes a meniscus of a nozzle to slightly oscillate to a degree that does not cause any liquid ejection, as well as a control method therefor.

2. Related Art

A liquid ejecting apparatus is an apparatus which is provided with a liquid ejection head capable of ejecting liquid as liquid droplets through nozzles, and which causes this liquid ejection head to eject various kinds of liquid. Representative examples of this liquid ejecting apparatus include an image recording apparatus, such as an ink jet recording apparatus (a printer) which is provided with an ink jet type record head (hereinafter, referred to as just a record head), and which performs printing by causing liquid-state ink to be ejected as ink droplets through nozzles of this record head. Besides, this liquid ejecting apparatus has been used for ejection of various kinds of liquid, such as a color material used in a color filter for a liquid crystal display and the like, an organic material used in an organic electro-luminescence (EL) display, and an electrode material used in an electrode formation. Further, a record head for an image recording apparatus ejects liquid-state inks, and a color material ejection head for a display manufacturing apparatus ejects solutions of color materials each for a corresponding one of red (R), green (G) and blue (B) colors. Further, an electrode material ejection head for an electrode formation apparatus ejects liquid-state electrode materials, and a living organic material head for a chip manufacturing apparatus ejects solutions of living organic materials.

With respect to this kind of liquid ejection head, in a nozzle, liquid (meniscus) is exposed to outside air, and thus, the evaporation of solvent components included in the liquid, or the like, sometimes, causes a viscosity increase of the liquid. This viscosity increase of liquid is likely to cause a situation where the liquid is not normally ejected through the nozzle. In order to suppress such a viscosity increase of liquid, during a liquid ejecting operation (for example, during a printing operation regarding a printer), with respect to a nozzle through which liquid is not ejected, liquid contained in a pressure chamber corresponding to the nozzle as well as a meniscus of the nozzle are caused to slightly oscillate to a degree that does not cause the liquid to be ejected through the nozzle by driving a pressure generation means (for example, a piezoelectric element, a heater element or the like) corresponding to the nozzle through applying a slight oscillation pulse to the pressure generation means. That is, this slight oscillation operation causes agitation of liquid existing in an area around the nozzle, so that the viscosity increase is suppressed (for example, refer to JP-A-2000-037867).

In a technology disclosed in JP-A-2000-037867, a driving pulse for the slight oscillation is a pulse whose driving voltage is set so as to be lower than that of an ejection driving pulse which, when performing printing, causes ink to be ejected by driving a pressure generation means.

Meanwhile, recently, such a printer as described above has been used for ejection of various types of ink. Among these types of ink, there are some types of ink each having viscosity likely to increase. Further, the some types of ink include a type of ink in which a particularly large amount of a solid component, such as a color material or a resin, is contained, or a type of ink whose viscosity is relatively high. When the viscosity of ink has increased to a certain level, it is necessary to perform a cleaning process to forcibly suck and discharge the ink from a nozzle. Such a cleaning process consumes a large amount of ink, and thus, it is preferable to reduce the frequency of performing the cleaning process to a level as low as possible. In order to improve a so-called intermittent capability, which is related to a tolerable time within which a state where any cleaning process and any ink ejection are not performed can be kept as it is, it is necessary to improve an effect of agitating ink by raising a voltage of a slight oscillation pulse to a certain degree. Nevertheless, the raise of a voltage of the slight oscillation pulse results in an increase of the oscillation of a meniscus by a degree corresponding to a raised voltage of the slight oscillation pulse, and thus, there has been a disadvantage in that the resultant residual oscillation of the meniscus is likely to give an adverse effect on an ejection stability in subsequent printing operations. Specifically, there has been a disadvantage in that, with respect to ink ejected through a nozzle, the variation of an ink amount, the occurrence of flight bending and the like are likely to occur.

### SUMMARY

An advantage of some aspects of the invention is to provide a liquid ejecting apparatus and a control method therefor which enable realization of both of the improvement of an intermittent capability and an ejection stability.

A liquid ejecting apparatus according to a first aspect of the invention, which is a liquid ejecting apparatus to be provided, includes a liquid ejection head that includes a nozzle through which liquid is ejected, a pressure chamber which communicates with the nozzle, and a pressure generation means which causes liquid contained in the pressure chamber to be subjected to a pressure variation, and that causes liquid to be ejected through the nozzle by driving the pressure generation means; and a drive waveform generation means that generates a slight oscillation waveform which does not cause liquid to be ejected through the nozzle, wherein the slight oscillation waveform includes a first variation element which varies up to a first electric potential of a first polarity relative to a reference electric potential and thereby causes liquid contained in the pressure chamber to be subjected to a pressure variation, a second variation element which varies up to a second electric potential of a second polarity, which is different from the first polarity, relative to the reference electric potential and thereby causes liquid contained in the pressure chamber to be subjected to a pressure variation, a third variation element which varies up to a third electric potential of the first electric potential and thereby causes liquid contained in the pressure chamber to be subjected to a pressure variation, and a fourth variation element which varies up to the reference electric potential and thereby causes liquid contained in the pressure chamber to be subjected to a pressure variation.

According to the first aspect of the invention, the slight oscillation waveform includes the first variation element which varies up to a first electric potential of a first polarity relative to a reference electric potential and thereby causes liquid contained in the pressure chamber to be subjected to a pressure variation, the second variation element which varies up to a second electric potential of a second polarity, which is different from the first polarity, relative to the reference electric potential and thereby causes liquid contained in the pressure chamber to be subjected to a pressure variation, the third variation element which varies up to a third electric potential of the first electric potential and thereby causes liquid contained in the pressure chamber to be subjected to a pressure variation, and the fourth variation element which varies up to the reference electric potential and thereby causes liquid contained in the pressure chamber to be subjected to a pressure variation. Thus, it becomes possible to cause the pressure chamber to be contracted to a greater degree by the second variation element, so that the effect of agitation of liquid is improved. Further, it becomes possible to allow the third variation element and the fourth variation element to function as waveform elements for suppressing pressure oscillation caused in the pressure chamber by the first variation chamber and the second variation chamber. Accordingly, when slight oscillation using the relevant slight oscillation waveform is applied, the viscosity increase of liquid can be suppressed and the intermittent capability can be improved, and concurrently therewith, the behavior of the meniscus after the completion of the slight oscillation operation can be suppressed, and thus, it becomes possible to ensure the stability of ejection of liquid in a subsequent ejection operation.

Further, a liquid ejecting apparatus according to a second aspect of the invention includes a liquid ejection head that includes a nozzle through which liquid is ejected, a pressure chamber which communicates with the nozzle, and a pressure generation means which causes liquid contained in the pressure chamber to be subjected to a pressure variation, and that causes liquid to be ejected through the nozzle by driving the pressure generation means; and a drive waveform generation means that generates a slight oscillation waveform which does not cause liquid to be ejected through the nozzle, wherein the slight oscillation waveform includes a first variation element which varies from a reference electric potential up to a first electric potential of a first polarity relative to the reference electric potential and thereby causes liquid contained in the pressure chamber to be subjected to a pressure variation, a second variation element which varies from the first variation element up to a second electric potential of a second polarity, which is different from the first polarity, relative to the reference electric potential and thereby causes liquid contained in the pressure chamber to be subjected to a pressure variation, a third variation element which varies from the second variation element up to a third electric potential of the first electric potential and thereby causes liquid contained in the pressure chamber to be subjected to a pressure variation, and a fourth variation element which varies from the third variation element up to the reference electric potential and thereby causes liquid contained in the pressure chamber to be subjected to a pressure variation.

According to this configuration, the slight oscillation waveform includes the first variation element which varies from a reference electric potential up to a first electric potential of a first polarity relative to the reference electric potential and thereby causes liquid contained in the pressure chamber to be subjected to a pressure variation, the second variation element which varies from the first variation element up to a second electric potential of a second polarity, which is different from the first polarity, relative to the reference electric potential and thereby causes liquid contained in the pressure chamber to be subjected to a pressure variation, the third variation element which varies from the second variation element up to a third electric potential of the first electric potential and thereby causes liquid contained in the pressure chamber to be subjected to a pressure variation, and the fourth variation element which varies from the third variation element up to the reference electric potential and thereby causes liquid contained in the pressure chamber to be subjected to a pressure variation, and thus, it becomes possible to cause the electric potential to vary across the boundary of the opposite polarities. Accordingly, the intermittent capability can be improved by suppressing the viscosity increase of liquid further effectively, and at the same time, the behavior of the meniscus after the completion of the slight oscillation operation can be suppressed, and thus, it becomes possible to ensure the stability of ejection of liquid in a subsequent ejection operation.

Further, in the above configurations, it is preferable to employ a configuration in which the first electric potential and the third electric potential are equal to each other.

According to this configuration, the behavior of the meniscus after the completion of the slight oscillation operation can be suppressed, and thus, it becomes possible to ensure the stability of ejection of liquid in a subsequent ejection operation.

Further, in the above configurations, it is preferable to employ a configuration in which the first electric potential and the third electric potential are different from each other.

According to this configuration, it is possible to set the third electric potential appropriately, and thus, it becomes possible to improve a capability of suppressing the behavior of the meniscus after the completion of the slight oscillation operation.

Further, in the above configurations, it is preferable to employ a configuration in which the second variation element is applied to the pressure generation means at timing of generating pressure oscillation capable of activating pressure oscillation which is excited inside liquid contained in the pressure chamber by the first variation element.

According to this configuration, the second variation element is applied to the pressure generation means at timing of generating pressure oscillation capable of activating pressure oscillation which is excited inside liquid contained in the pressure chamber by the first variation element, and thus, the meniscus is caused to oscillate and the liquid is effectively agitated, so that it becomes possible to improve the intermittent capability.

Further, in the above configurations, it is preferable to employ a configuration in which a period of time from a start of the second variation element to an end of the fourth variation element is equal to a period of time resulting from multiplying a natural oscillation cycle of liquid contained in the liquid chamber by a natural number.

According to this configuration, it is possible to agitate the liquid by allowing the second variation element to activate oscillation of the meniscus, having arisen during the operation of the first variation element, and further, allow the third variation element and the fourth variation element to suppress the oscillation of the meniscus, so that it becomes possible to ensure the intermittent capability and the ejection stability further efficiently.

Further, a control method for controlling a liquid ejecting apparatus, according to a third aspect of the invention, is a control method for a liquid ejecting apparatus including a liquid ejection head that includes a nozzle through which liquid is ejected, a pressure chamber which communicates with the nozzle, and a pressure generation means which causes liquid contained in the pressure chamber to be subjected to a pressure variation, and that causes liquid to be ejected through the nozzle by driving the pressure generation means; and a drive waveform generation means that generates a slight oscillation waveform which does not cause liquid to be ejected through the nozzle. Further, this control method includes causing a slight oscillation operation to be performed by applying a slight oscillation waveform to the pressure generation means, the slight oscillation waveform including a first variation element which varies up to a first electric potential of a first polarity relative to a reference electric potential and thereby causes liquid contained in the pressure chamber to be subjected to a pressure variation, a second variation element which varies up to a second electric potential of a second polarity, which is different from the first polarity, relative to the reference electric potential and thereby causes liquid contained in the pressure chamber to be subjected to a pressure variation, a third variation element which varies up to a third electric potential of the first electric potential and thereby causes liquid contained in the pressure chamber to be subjected to a pressure variation, and a fourth variation element which varies up to the reference electric potential and thereby causes liquid contained in the pressure chamber to be subjected to a pressure variation.

According to this configuration, it becomes possible to provide a high-quality liquid ejecting apparatus.

### BRIEF DESCRIPTION OF THE DRAWINGS

The invention will be described with reference to the accompanying drawings, wherein like numbers reference like elements.

FIG. 1 is a perspective view illustrating a configuration of a printer according to an embodiment of the invention.

FIGS. 2A, 2B and 2C are diagrams each illustrating a configuration of a record head according to an embodiment of the invention.

FIG. 3 is a block diagram illustrating an electric configuration of a printer according to an embodiment of the invention.

FIG. 4 is a waveform diagram for describing a configuration of a driving signal according to an embodiment of the invention.

FIG. 5 is a waveform diagram for describing a configuration of a slight oscillation driving pulse according to an embodiment of the invention.

FIG. 6 is a table illustrating a result of a validation which was performed with respect to an intermittent capability and ejection stability.

FIGS. 7A and 7B are waveform diagrams each for describing a driving signal in a comparison example.

FIGS. 8A, 8B and 8C are waveform diagrams each describing a modification example of a slight oscillation driving pulse.

### DESCRIPTION OF EXEMPLARY EMBODIMENTS

Hereinafter, an embodiment to practice the invention will be described with reference to the accompanying drawings. It is to be noted here that, although an embodiment described below is subjected to various limitations as a preferable specific example of the invention, the scope of the invention is not limited to this embodiment described below, except for portions each being particularly given a notice indicating a limitation of the invention. Further, in the following description, an ink jet recording apparatus (hereinafter referred to as just a printer) will be exemplified as a liquid ejecting apparatus according to an aspect of the invention.

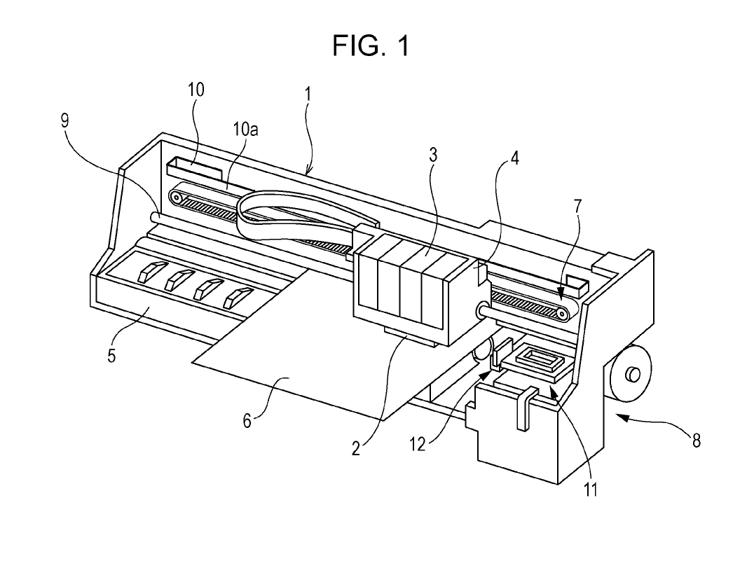

FIG. 1 is a perspective view illustrating a configuration of a printer 1. This printer 1 mainly includes a carriage 4 to which a record head 2, which is a kind of liquid ejection head, is attached, as well as ink cartridges 3 each being a kind of liquid feeding source are detachably attached; a platen 5 provided below the record head 2 which is under a recording operation; a carriage movement mechanism 7 which causes the carriage 4 to reciprocally move in a direction along the paper width of record paper 6 (a kind of recording medium or a kind of liquid landing target), that is, in a main scanning direction; and a paper transportation mechanism 8 which transports the record paper 6 in a sub scanning direction perpendicular to the main scanning direction.

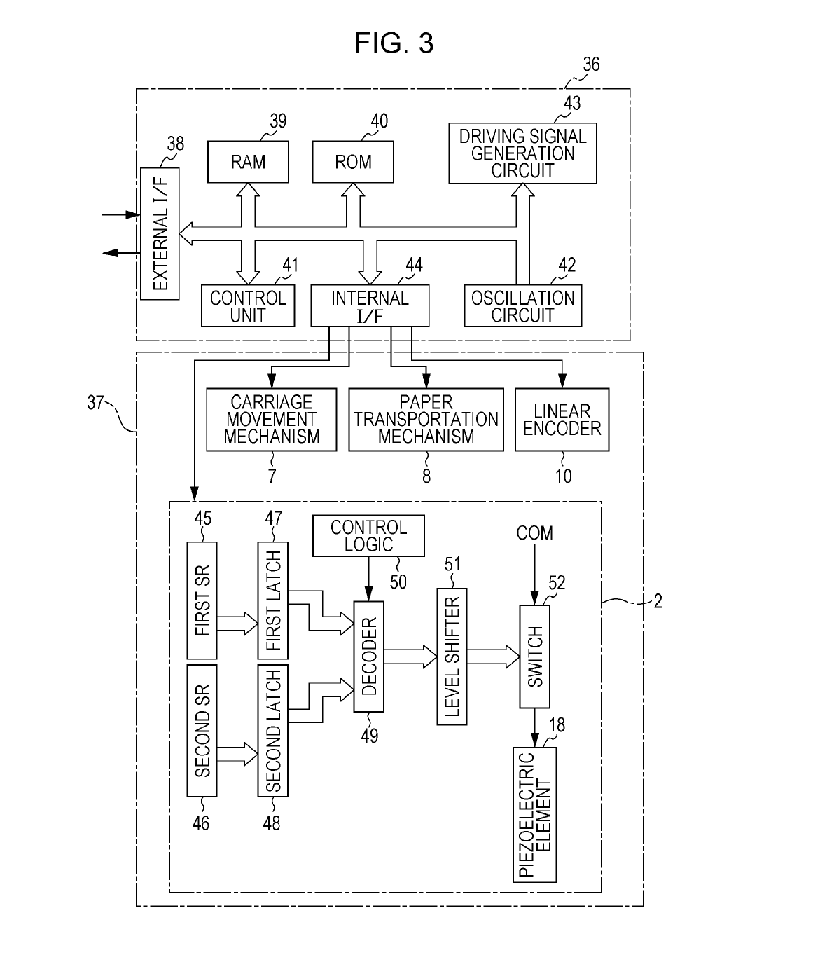

The carriage 4 is attached to a guide rod 9, which is installed across the housing of the printer 1 in the main scanning direction, in a state of being pivotably supported by the guide rod 9, and is configured so as to move in the main scanning direction along the guide rode 9 by being actuated by the carriage movement mechanism 7. The location of the carriage 4 in the main scanning direction is detected by a linear encoder 10, and the detected signal, that is, encoder pulses (a kind of location information), are sent to a control unit 41 (refer to FIG. 3) of a printer controller 36. The linear encoder 10 is a kind of location information output means, and outputs, as location information in the main scanning direction, encoder pulses in accordance with a scanning location of the record head 2. Thus, the control unit 41 can recognize a scanning location of the record head 2, which is mounted on the carriage 4, on the basis of the received encoder pulses. That is, the location of the carriage 4 can be recognized by, for example, counting the received encoder pulses. In this way, the control unit 41 can control recording operation performed by the record head 2 while recognizing the location of the carriage 4 (the record head 2) on the basis of the encoder pulses sent from the linear encoder 10.

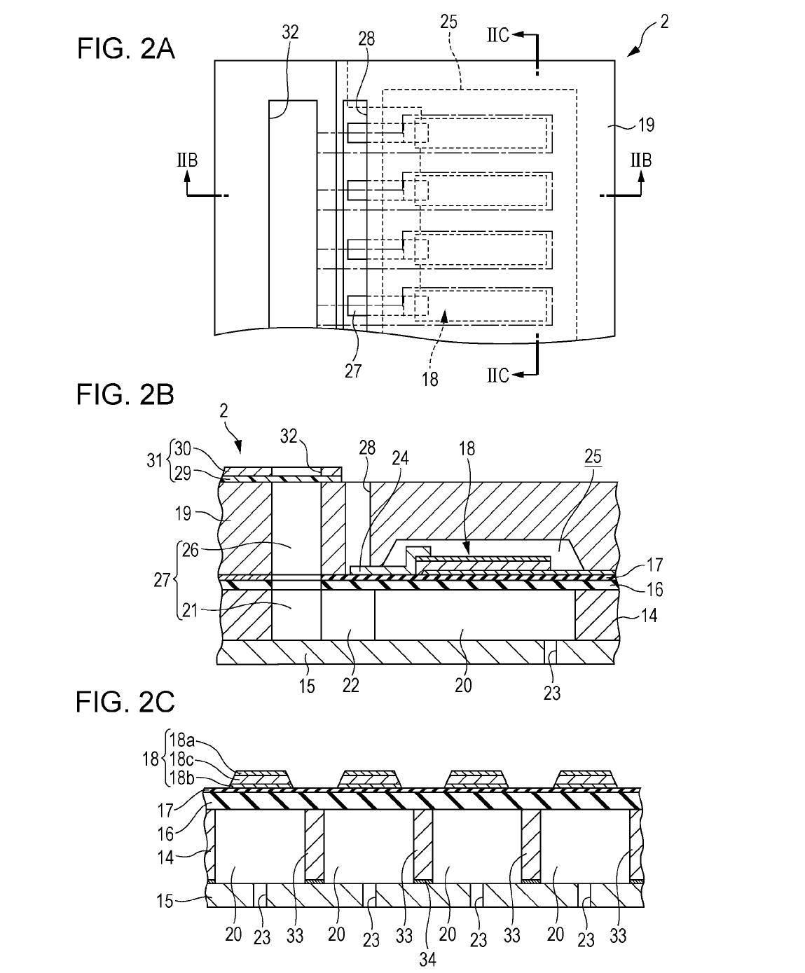

A home position, which is a base point of the carriage scanning, is provided in an edge area located outer than a recording area falling within a movement range of the carriage 4. At the home position in this embodiment, there are disposed a capping member 11 for sealing a nozzle forming face (a nozzle forming substrate 15: refer to FIG. 2), and a wiper member 12 for wiping the nozzle forming face. Further, the printer 1 is configured so as to make it possible to perform so-called bidirectional recording, that is, recording of characters, images and the like on the record paper 6 during bidirectional operations including an outward operation in which the carriage 4 moves from the home position to an opposite side edge portion, and a homeward operation in which the carriage 4 returns from the opposite side edge portion to the home position.

A not-illustrated platen heater (a heating means) is provided inside the platen 5 of the printer 1 according to this embodiment. Record paper or a recording medium on the platen 5 is heated by this platen heater, so that fixing and drying of ink having been landed on the record paper or the recording medium is accelerated.

FIGS. 2A, 2B and 2C are diagrams each illustrating a configuration of the record head 2. Further, FIG. 2A is a plan view of the record head 2; FIG. 2B is a sectional view taken along the line IIB-IIB of FIG. 2A; and FIG. 2C is a sectional view taken along the line IIC-IIC of FIG. 2A. In addition, in FIG. 2C, a protection substrate 19 is omitted from illustration. Further, in each of FIGS. 2A to 2C, just a configuration associated with four nozzles is exemplified, and configurations associated with nozzles other than these four nozzles are similar to the exemplified configuration. The record head 2 of this embodiment is configured so as to laminate a pressure chamber substrate 14, the nozzle forming substrate 15, an elastic film 16, an insulating film 17, a piezoelectric element 18, the protection substrate 19 and the like.

The pressure chamber substrate 14 is a board formed from, for example, a silicon single crystal substrate. In this pressure chamber substrate 14, a plurality of pressure chambers 20 are arranged in parallel in its width direction (in a nozzle row direction) such that every two adjacent ones of the pressure chambers 20 interpose a partition wall 33. In an area outer than the pressure chamber 20 in a direction along the long side of the pressure chamber 20 of the pressure chamber substrate 14 (i.e., in a direction perpendicular to the nozzle row direction), a communicating portion 21 is formed, and this communicating portion 21 and each of the pressure chambers 20 are communicated with each other via an ink feeding path 22 which is provided for each of the pressure chambers 20. In addition, the communicating chamber 21 communicates with a reservoir portion 26 included in the protection substrate 19 described below, and thereby constitutes part of a reservoir 27 which is an ink chamber common to the individual pressure chambers 20. The ink feeding path 22 has a width smaller than that of the pressure chamber 20, and thereby gives a flowing path resistance to ink flowing into the pressure chamber 20 from the communicating chamber 21. These pressure chambers 20, the ink feeding paths 22 and the like included in the pressure chamber substrate 14 are each formed by means of an anisotropic etching method.

The nozzle forming substrate 15, in which a plurality of nozzles 23 are each formed in an opening state, and are arranged in rows such that each of the nozzles 23 is associated with a corresponding one of the pressure chambers 20, is adhered to the lower face of the pressure chamber substrate 14 by using an adhesive agent 34. In this way, an opening at the lower face of each of the pressure chambers 20 is sealed by the nozzle forming substrate 15, and a bottom portion of each of the pressure chambers 20 is defined. That is, the nozzle forming substrate 15 also functions as a material for the bottom portion of each of the pressure chambers 20. The elastic film 16 composed of, for example, silicon dioxide (SiO₂) is formed on the upper face (a first opening face) of the pressure chamber substrate 14. Portions sealing the openings of the pressure chambers 20 in the elastic film 16 function as actuation faces.

The insulating film 17 composed of zirconium oxide (ZrO₂) is formed on the elastic film 16 described above. Further, on this insulating film 17, piezoelectric elements 18 are arranged such that each of the piezoelectric elements 18 is associated with a corresponding one of the pressure chambers 20. The exemplified piezoelectric element 18 is a so-called piezoelectric element in a bending oscillation mode, and is configured such that a piezoelectric material 18c is interposed between a driving electrode 18a and a common electrode 18b. Further, a lead electrode 24 composed of, for example, gold (Au) or the like is connected to the driving electrode 18a of each of the piezoelectric elements 18. Further, when a driving signal (a driving pulse) has been applied to the driving electrode 18a of the piezoelectric element 18, electric field in accordance with an electric-potential difference arises between the driving electrode 18a and the common electrode 18b. This electric field is applied to the piezoelectric material 18c, so that the piezoelectric material 18c is deformed in accordance with the strength of the electric field. That is, the higher the electric-potential of the driving electrode 18a is made, the central portion of the piezoelectric material 18c in its width direction (i.e., in the nozzle row direction) bends towards the inner side of the pressure chamber 20 (i.e., towards a side nearer the nozzle forming substrate 15) to an increasing degree, so that this bending deforms the elastic film 16 so as to make the volume of the pressure chamber 20 smaller. In contrast, the lower the electric-potential of the driving electrode 18a is made (that is, the nearer zero the electric-potential of the driving electrode 18a is made), the central portion of the piezoelectric material 18c in its short-side direction bends towards the outer side of the pressure chamber 20 (i.e., towards a side farther from the nozzle formation substrate 15) to an increasing degree, so that this bending deforms the elastic film 16 so as to make the volume of the pressure chamber 20 larger.

The protection substrate 19 is adhered to the piezoelectric element 18 side face of the pressure chamber substrate 14. Further, the protection substrate 19 includes piezoelectric element retaining portions 25 each being a space having a size of a degree sufficient not to disturb the displacement of the piezoelectric element 18, and being located at an area facing the piezo electric element 18. Moreover, the protection substrate 19 is provided with a reservoir portion 26 in an area corresponding to the communicating portion 21 of the pressure chamber substrate 14. This reservoir portion 26 is formed in the protection substrate 19 as a penetrating hole of a rectangular opening shape having a long side along the direction in which the pressure chambers 20 are arranged. Further, as described above, this reservoir portion 26 defines the reservoir 27 together with the communicating portion 21 of the pressure chamber substrate 14, which communicates with the reservoir portion 26 itself. This reservoir 27 is provided for each kind of ink (for each color), and reserves ink common to more than two ones of the pressure chambers 20.

Further, a penetrating hole 28 which penetrates the protection substrate 19 in its thickness direction is provided in an area between the piezoelectric retaining portion 25 and the reservoir portion 26 which are included in the protection substrate 19, and a portion of the common electrode 18b and an edge of the lead electrode 24 are exposed within this penetrating hole 28. A compliance substrate 31 including a sealing film 29 and a fixing plate 30 is adhered onto the protection substrate 19. This sealing film 29 is composed of a material having flexibility (for example, a polyphenylene sulfide film), and this sealing film 29 seals one of the faces of the reservoir portion 26. Further, the fixing plate 30 is composed of a hard material, such as a metallic material (for example, a stainless steel material or the like). An area facing the reservoir 27, included in the fixing plate 30, is an opening 32 penetrating in the thickness direction of the fixing plate 30. Thus, one of the faces of the reservoir 27 is sealed by only the sealing film 29 having flexibility.

In the record head 2 configured in such a way as described above, ink is fed from an ink feeding means, such as an ink cartridge, so that portions from the reservoir 27 up to the nozzle 23 are filled with the ink. Further, the supply of a driving signal from the main frame of the printer causes electric field in accordance with an electric-potential difference of the common electrode 18b and the driving electrode 18a, between the common electrode 18b and the driving electrode 18a which correspond to each of the pressure chambers 20, so that the piezoelectric element 18 and the actuation face (the elastic film 16) bend and are deformed, and this deformation causes a pressure variation inside the pressure chamber 20. Through control of this pressure variation, ejection of ink through the nozzle 23 is controlled.

FIG. 3 is a block diagram illustrating an electric configuration of the printer 1. The printer 1 according to this embodiment roughly includes a printer controller 36 and a print engine 37. This print engine 36 includes an external interface (an external I/F) 38 to which pieces of print data and the like from an external apparatus, such as a host computer, are inputted; a RAM 39 that stores therein various pieces of data and the like; a ROM 40 that stores therein control programs and the like for various kinds of control; a control unit 41 that performs overall control of individual portions in accordance with the control programs stored in the ROM 40; an oscillation circuit 42 that generates clock signals; a driving signal generation circuit 43 (a kind of driving waveform generation means); and an internal interface (an internal I/F) 44 through which dot pattern data, which is obtained by developing print data into pieces of data for each dot, driving signals and the like are outputted to the record head 2. Further, the print engine 37 includes the record head 2, the carriage movement mechanism 7, the paper transportation mechanism 8 and the linear encoder 10.

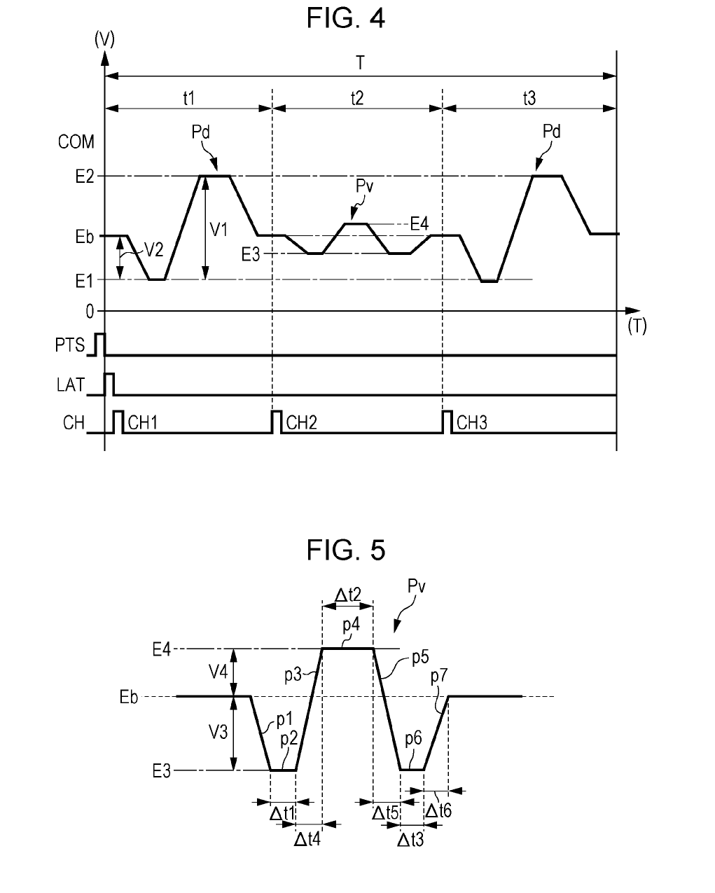

The control unit 41 functions as a timing pulse generation means for generating a timing pulse PTS (refer to FIG. 4) from the encoder pulses outputted from the linear encoder 10. This timing pulse PTS is a signal which determines timing of a start of generation of driving signals to be generated by the driving signal generation circuit 43. That is, the driving signal generation circuit 43 outputs driving signals every receipt of the timing pulse PTS. Further, the control unit 41 outputs latch signals LAT each determining latch timing for latching print data, as well as change (or channel) signals CH each determining selection timing for selecting a corresponding one of ejection driving pulses included in the driving signals.

The above driving signal generation circuit 43 generates a driving signal COM including a plurality of ejection driving pulses every receipt of the timing pulse PTS. In other words, the driving signal generation circuit 43 repeatedly generates the driving signal COM at intervals of a cycle (hereinafter, referred to as a unit cycle T) based on the above timing pulse PTS.

FIG. 4 is a diagram for describing an example of the configuration of the driving signal COM generated by the driving signal generation circuit 43 according to this embodiment. In addition, in this diagram, a horizontal axis and a vertical axis represent time and electric potential, respectively. The driving signal COM of this embodiment is a signal which includes totally three driving pulses within its unit cycle T. In this embodiment, the unit cycle T of the driving signal COM is divided into three periods (pulse generation periods) t1 to t3. Further, an ejection driving pulse Pd is generated during the period t1; a slight oscillation driving pulse Pv (corresponding to the slight oscillation driving waveform in any one of the aspects of the invention) is generated during the period t2; and the ejection diving pules Pd is generated during the period t3. The details of these driving pulses will be described below.

Next, an electric configuration of this record head 2 will be described. As shown in FIG. 3, this record head 2 includes a shift register (SR) circuit composed of a first shift register 45 and a second shift register 46; a latch circuit composed of a first latch circuit 47 and a second latch circuit 48; a decoder 49; a control logic 50; a level shifter 51; a switch 52; and the piezoelectric element 18. Further, the first shift register 45, the second shift register 46, the first latch circuit 47, the second latch circuit 48, the level shifter 51, the switch 52 and the piezoelectric element 18 are each provided by a total number equal to the total number of the nozzles 23. In addition, in FIG. 3, a configuration of only a nozzle is illustrated and configurations of nozzles other than this nozzle are omitted from illustration.

This record head 2 performs ejection control of ink (a kind of liquid) on the basis of print data (pixel data) SI sent from the printer controller 36. In this embodiment, the print data SI, each piece thereof being composed of two bits, is sent to the record head 2 in synchronization with a clock signal CLK in order of a series of upper bits of the print data SI and a series of lower bits of the print data SI, and thus, first, a series of upper bits of the print data SI is set in the second shift register 46. When a series of upper bits of the print data SI has been completely set in the second sift register 46 for each of all the nozzles 23, next, this series of upper bits begins to shift into the first shift register 45. Concurrently therewith, a series of lower bits of the print data SI begins to shift into the second shift register 46.

The first latch circuit 47 is electrically connected to the first shift register 45 as a subsequent stage of the first shift register 45, and the second latch circuit 48 is electrically connected to the second shift register 46 as a subsequent stage of the second shift register 46. Further, when a latch pulse from the printer controller 36 side has been inputted to each of the latch circuits 47 and 48, the first latch circuit 47 latches the series of upper bits, and the second latch circuit 48 latches the series of lower bits. Groups of pieces of record data, each of the groups being latched in a corresponding one of the latch circuits 47 and 48, (i.e., the series of upper bits and the series of lower bits), are outputted to the decoder 49. This decoder 49 generates a piece of pulse selection data for selecting a corresponding one of the driving pulses included in the driving signal COM on the basis of the series of upper bits and the series of lower bits of the record data.

The driving signal COM from the driving signal generation circuit 43 is inputted to the input side of the switch 52. Further, the output side of the switch 52 is connected to the piezoelectric element 18. The switch 52 selectively supplies each of the driving pulses included in the driving pulse COM to the piezoelectric element 18 on the basis of the above piece of pulse selection data. The switch 52 performing such an operation as described above functions as a kind of selective supply means.

Here, in this embodiment, as shown in FIG. 4, with respect to the driving signal COM, the slight oscillation driving pulse Pv is excited between the two ejection driving pulses Pd. Further, within a certain one of the unit cycles T during an operation of recording (during an operation of printing) onto a recording medium, the slight oscillation driving pulse Pv is selected and applied to one of the piezoelectric elements 18, associated with one of the nozzles 23, which is in a state where no ink is to be ejected through the nozzle 23 itself. This application of the slight oscillation driving pulse Pv drives the piezoelectric element 18 associated with the nozzle 23 which is in a state of being not involved in recording, so that a pressure variation (slight oscillation) of a degree that does not cause any ejection of ink though the nozzle 23 occurs in ink contained in the pressure chamber 20. Moreover, this slight oscillation causes agitation regarding ink inside the pressure chamber 20 as well as a meniscus, thereby enabling prevention of a viscosity increase of the ink.

FIG. 5 is a waveform diagram for describing a configuration of the slight oscillation driving pulse Pv according to this embodiment. The slight oscillation driving pulse Pv according to this embodiment is composed of a first expansion element p1 (corresponding to the first variation element in any one of the aspects of the invention); a first hold element p2; a contraction element p3 (corresponding to the second variation element in any one of the aspects of the invention); a second hold element p4; a second expansion element p5 (corresponding to the third variation element in any one of the aspects of the invention); a third hold element p6; and a return element p7 (corresponding to the fourth variation element in any one of the aspects of the invention). The first expansion element p1 is an element whose electric potential varies (falls) from a reference electric potential Eb, which corresponds to a reference volume (a volume to be referred to as a baseline with respect to an expansion and a contraction), up to a first slight oscillation expansion electric potential E3 (corresponding to the first electric potential in any one of the aspects of the invention) at the negative polarity side relative to the reference electric potential Eb. This first slight oscillation expansion electric potential E3 has a value between the reference electric potential Eb and a minimum electric potential E1 of the ejection driving pulse Pd. Electric-potential gradients (each being an electric-potential variation ratio per unit time) of the first expansion element p1, the contraction element p3, the second expansion element p5 and the return element p7 are each set to a value of a degree that does not allow ejection of ink through the relevant nozzle 23 associated with the piezoelectric element 18 to which the first expansion element p1 has been applied. Further, the first hold element p2 is a waveform element for holding the first slight oscillation expansion electric potential E3, which is a termination electric potential of the first expansion element p1, during a constant period of time Δt1.

The contraction element p3 is a waveform element which is generated subsequent to the first hold element p2. Further, the contraction element p3 is a waveform element whose electric potential varies (rises) with a constant gradient from the first slight expansion electric potential E3, across the reference electric potential Eb and up to the slight oscillation contraction electric potential E4 (corresponding to the second electric potential in any one of the aforementioned aspects of the invention) at the positive polarity side relative to the reference electric potential Eb. The second hold element p4 is a waveform element for holding the slight oscillation contraction electric potential E4, which is a termination electric potential of the contraction element p3, during a constant period of time Δt2. The second expansion element p5 is a waveform element whose electric potential varies from the slight oscillation contraction electric potential E4 up to the first slight oscillation expansion electric potential E3 (corresponding to the third electric potential in any one of the aforementioned aspects of the invention), that is, up to the negative polarity side. Further, the third hold element p6 is a waveform element for holding the first slight oscillation expansion electric potential E3 during a constant period of time Δt3. Further, the return element p7 is a waveform element which returns with a constant gradient from the first slight expansion electric potential E3 up to the reference electric potential Eb.

When the slight oscillation driving pulse Pv configured in such a way as described above has been applied to the piezoelectric element 18, this application causes operation described below.

First, the application of the first expansion element p1 to the piezoelectric element 18 causes the width-direction central portion of each of the relevant piezoelectric element 18 and a corresponding actuation portion of the elastic film 16 to bend towards the outer side of the pressure chamber 20 (towards a side farther from the nozzle forming substrate 15). This bending causes the pressure chamber 20 to expand from the reference volume corresponding to the reference electric potential Eb to a first expanded volume corresponding to the first slight oscillation expansion electric potential E3. This expansion causes a meniscus in the nozzle 23 to be pulled in towards the pressure chamber 20 side, and concurrently therewith, the expansion causes ink to be fed to the inside of the pressure chamber 20 from the reservoir 27 through a feeding opening. This expansion state of the pressure chamber 20 is kept during a period when the first hold element p2 is applied. Subsequently, the contraction element p3 causes the width-direction central portion of each of the piezoelectric element 18 and the corresponding actuation portion of the elastic film 16 to bend towards the inner side of the pressure chamber 20 (towards a side nearer the nozzle forming substrate 15) to a large degree. This bending causes the pressure chamber 20 to rapidly contract from the expanded volume corresponding to the slight oscillation expansion electric potential E3 up to a contracted volume corresponding to the slight oscillation contraction electric potential E4. This rapid contraction of the pressure chamber 20 causes ink inside the pressure chamber 20 to be pressurized, so that pressure oscillation occurs, and this pressure oscillation causes agitation of ink inside the pressure chamber 20 as well as the meniscus. Here, an electric-potential difference from the reference electric potential Eb to the slight oscillation electric potential E3 is called V3, and an electric-potential difference from the reference electric potential Eb to the slight oscillation contraction electric potential E4 is called V4. With respect to the slight oscillation driving pulse Pv in this embodiment, an electric-potential difference (V3+V4) of the contraction element p3 is set to a larger value as compared with those in conventional methods, and thus, the effect of the agitation of ink is improved to a greater degree.

Further, this expansion state of the pressure chamber 20 is kept during a period when the second hold element p4 is applied. Subsequently, the application of the second expansion element p5 causes the central portion of each of the piezoelectric element 18 and the corresponding actuation portion of the elastic film 16 to bend towards the outer side of the pressure chamber 20. This bending causes the pressure chamber 20 to expand again from the contracted volume to the expanded volume corresponding to the first slight oscillation expansion electric potential E3. Subsequently, the contracted state of the pressure chamber 20 is kept during a period when the third hold element p6 is applied. Subsequent to the application of the third hold element p6, the return element p7 is applied to the piezoelectric element 18. This causes the central portion of each of the piezoelectric element 18 and the corresponding actuation portion of the elastic film 16 to bend towards the inner side of the pressure chamber 20, and return to the reference state.

Here, timing when the contraction element p3 is applied to the piezoelectric element 18 is set such that this timing becomes timing at which pressure oscillation, which arises when the pressure chamber 20 is expanded by the expansion element p1, can be activated. Further, timing points when the second hold element p4, the second expansion element p5, the third hold element p6 and the return element p7 are applied to the piezoelectric element 18 are set such that these timing points become timing points at which the pressure oscillation having been excited by the expansion element p1 and the contraction element p3 are caused to be suppressed. Specifically, a period of time Δt4 regarding the contraction element p3, the period of time Δt2 regarding the second hold element p4, a period of time Δt5 regarding the second expansion element p5, the period of time Δt3 regarding the third hold element p6 and a period of time Δt6 regarding the return element p7 are adjusted such that a period of time from the start of the contraction element p3, at which the activation of pressure oscillation starts, up to the end of the return element p7, which activates pressure oscillation having a phase reverse to that of the pressure oscillation having been excited by the expansion element p1, becomes a value resulting from multiplying a cycle Tc (a natural oscillation cycle) of the pressure oscillation which occurs in ink inside the pressure chamber 20 by a natural number. This adjustment activates the pressure oscillation having been excited by the expansion element p1, thereby causing the meniscus to oscillate and causing the ink to be effectively agitated, and further, reduces the pressure oscillation inside the pressure chamber 20 having been excited by the expansion element p1 and having been activated by the contraction element p3. Accordingly, even when the ink is ejected after the completion of the slight oscillation operation, the influence of the residual oscillation can be suppressed, and thus, it becomes possible to ensure the ejection stability.

Here, in general, the above Tc can be represented by the following formula:

Tc=2π√[(Mn+Ms)/(Mn×Ms×(Cc+Ci))]

In the above formula, Mn is inertance (mass of ink per unit of sectional area) of the nozzle 23; Ms is inertance of the ink feeding path 22; Cc is compliance (a volume variation per unit of pressure, that is, a degree of softness) of the pressure chamber 20; and Ci is compliance of ink (Ci=volume V/[density ρ×acoustic velocity c²]).

Through the employment of the slight oscillation driving pulse Pv having been described above, it becomes possible to allow the contraction element p3 to contract the pressure chamber 20 to a great degree, so that the effect of agitation of ink is improved. Further, it is possible to allow the second hold element p4, the second expansion element p5, the third hold element p6, the return element p7 to function as waveform elements for suppressing the pressure oscillation having been excited inside the pressure chamber 20. Accordingly, in the case where slight oscillation using the slight oscillation pulse Pv is excited, the viscosity increase is suppressed, so that the intermittent capability can be improved, and further, the behavior of the meniscus after the completion of the slight oscillation operation can be suppressed, and thus, it becomes possible to ensure the stability of ink ejection in a subsequent ejection operation. Further, through the employment of a control method for allowing slight oscillation to be excited in such a way as described above, it becomes possible to provide a printer of high reliability.

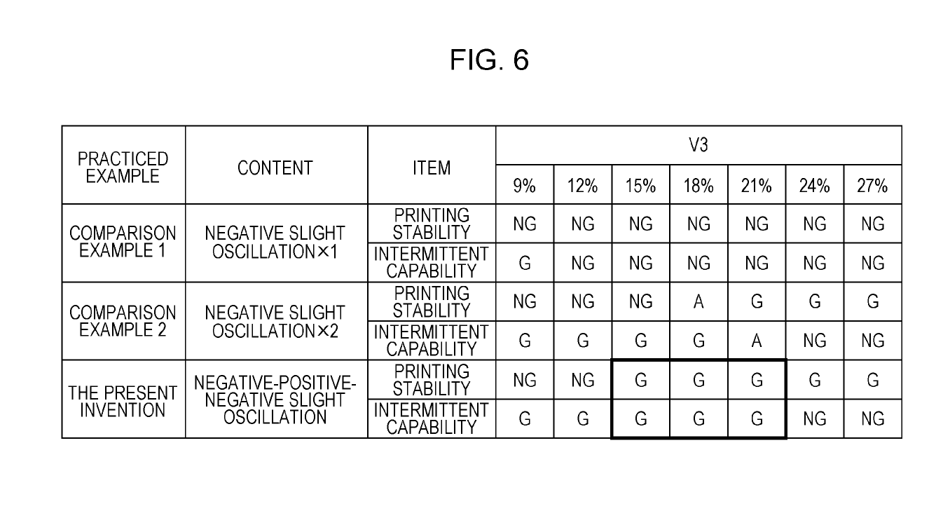

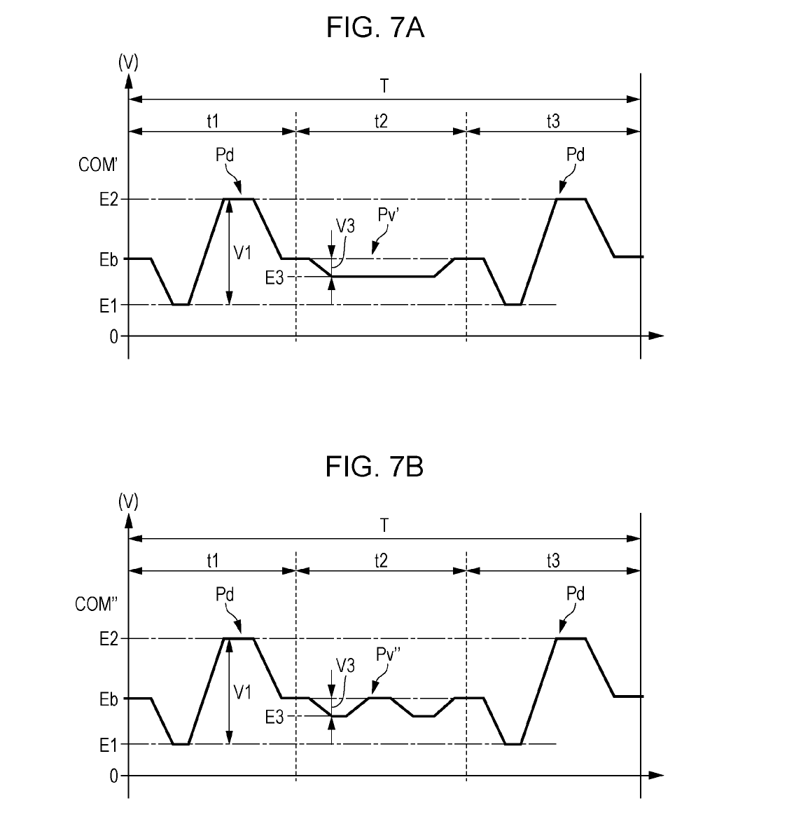

FIG. 6 is a table illustrating a result of validation regarding the intermittent capability and the ejection stability (printing stability) with respect to a case where slight oscillation using the slight oscillation driving pulse Pv according to this embodiment is excited, and a case where slight oscillation using a conventional slight oscillation driving pulse is excited. Further, FIGS. 7A and 7B are waveform diagrams each for describing a comparison example in which a conventional slight oscillation pulse is employed. A slight oscillation driving pulse Pv′ in comparison example 1 of FIG. 7A illustrates a waveform of electric potential which varies between the reference electric potential Eb and the slight oscillation expansion electric potential E3, the waveform thereof being formed like an inverted trapezoid. That is, the electric potential varies from the reference electric potential Eb up to the slight oscillation expansion electric potential E3 with a gradient of a degree that does not cause ejection of ink through a nozzle. Subsequently, the electric potential is kept at the slight oscillation expansion electric potential E3 during a constant period of time, and then, is returned from the slight oscillation expansion electric potential E3 to the reference electric potential Eb with a gradient of a degree that does not cause ejection of ink through the nozzle. That is, an inverted-trapezoid shaped pulse is included in the driving signal, and electric potential of this pulse varies to the negative polarity side relative to the reference electric potential Eb. Further, in comparison example 2 shown in FIG. 7B, two inverted-trapezoid shaped pulses are included in the driving signals, and electric potential of each of these two pulses varies between the reference electric potential Eb and the slight oscillation expansion electric potential E3. With respect to the slight oscillation driving pulse Pv according to this embodiment, the contraction element p3, which is an electric-potential element that agitates ink by contracting the pressure chamber 20, has a variation range of (V3+V4), that is, the contraction element p3 varies from the slight oscillation expansion electric potential E3, across the reference electric potential Eb, and up to the slight oscillation contraction electric potential E4; while, with respect to each of the slight oscillation driving pulse Pv′ of the comparison example 1 and the slight oscillation driving pulse Pv″ of the comparison example 2, its variation is up to the electric-potential difference V3 between the slight oscillation expansion electric potential E3 and the reference electric potential Eb.

The table of FIG. 6 illustrates validation results with respect to the intermittent capability as well as the ejection stability (printing stability) in recording operation after the completion of the slight oscillation operation when V3 of each of the above slight oscillation driving pulses is variously changed. In addition, the validation results are represented by signs “G” (good), “A” (not good but acceptable) and “NG” (not good). Further, in the case of the slight oscillation driving pulse Pv according to this embodiment, the validation was performed under the condition V4 was fixed to a constant value. Further, the intermittent capability means, for example, a tolerable time within which, after the completion of the slight oscillation operation, a state where any ink ejection is not performed can be kept as it. In the table, V3 is represented by a ratio (%) relative to the driving voltage V1 of the ejection driving pulse Pd. In any case, the validation was performed under the same environmental condition (regarding temperature and humidity) by using an identical record head 2 and identical inks. Here, “G” regarding the intermittent capability indicates a case where a no-ink-ejection state tolerable time, within which any failure due to the viscosity of ink does not occur, is larger than a given period of time (corresponding to, for example, a no-ink-ejection state tolerable time required in a specification or a design of the printer 1). In contrast, “NG” regarding the intermittent capability indicates a case where the above tolerable time is smaller than the given period of time. “A” regarding the intermittent capability indicates a case where, although the no-ink-ejection state tolerable time is larger than the given period of time, a failure possibly occurs depending on kinds of inks, a temperature condition and the like. Further, “G” regarding the ejection stability indicates a case where, within the same cycle T, after the completion of the slight oscillation operation, when the ejection driving pulse Pd has caused ink to be ejected during the period t3, a degree of the flight bending of ink falls within a given tolerable range, and further, a variation of the ink amount falls within another given tolerable range. In contrast, “NG” regarding the ejection stability indicates a case where, within the same cycle T, after the completion of the slight oscillation operation, when the ejection driving pulse Pd has caused ink to be ejected during the period t3, a degree of the flight bending of ink exceeds the given tolerable range, and/or a variation of the ink amount exceeds the another given tolerable range, so that a quality of image or the like targeted for recording is likely to degrade. “A” regarding the ejection stability indicates a case where, although the degree of the flight bending of ink falls within the given tolerance range and the variation of the ink amount falls within the another given tolerance range, a quality of image or the like targeted for recording possibly degrades depending on the kind of the image or the like targeted for recording.

In the case of comparison example 1, an ink agitation capability is relatively small, and although V3 was caused to vary from 9% to 27%, an intermittent capability higher than a required level could not be obtained. Further, with respect to the printing stability, only in the case where V3 was 9%, the result was “G”, and in each of the other cases, the result was “NG”, and thus, any good result could not be obtained. Further, in the case of comparison example 2, in the case where V3 was larger than or equal to 21%, the intermittent capability was good, but in contrast, the ejection stability was “A” or “NG”, and in the case where V3 was smaller than or equal to 18%, reversely, the ejection stability was good, but in contrast, the intermittent capability was “A” or “NG”. Accordingly, the result was such that, in both of comparison example 1 and comparison example 2, it was difficult to realize both of the improvement of the intermittent capability and the improvement of the ejection stability. In contrast, in the case where slight oscillation using the slight oscillation driving pulse Pv was excited, the result was such that, within a range between 15% and 21%, both of the intermittent capability and the ejection stability were “G”, and a range in which both of the intermittent capability and the ejection stability were higher than their corresponding required levels (the range corresponding to a portion enclosed by a heavy-line frame in FIG. 6) is larger as compared with in each of the other comparison examples.

Meanwhile, the invention is not limited to the aforementioned embodiment, and may be subjected to various modifications based on description in appended claims.

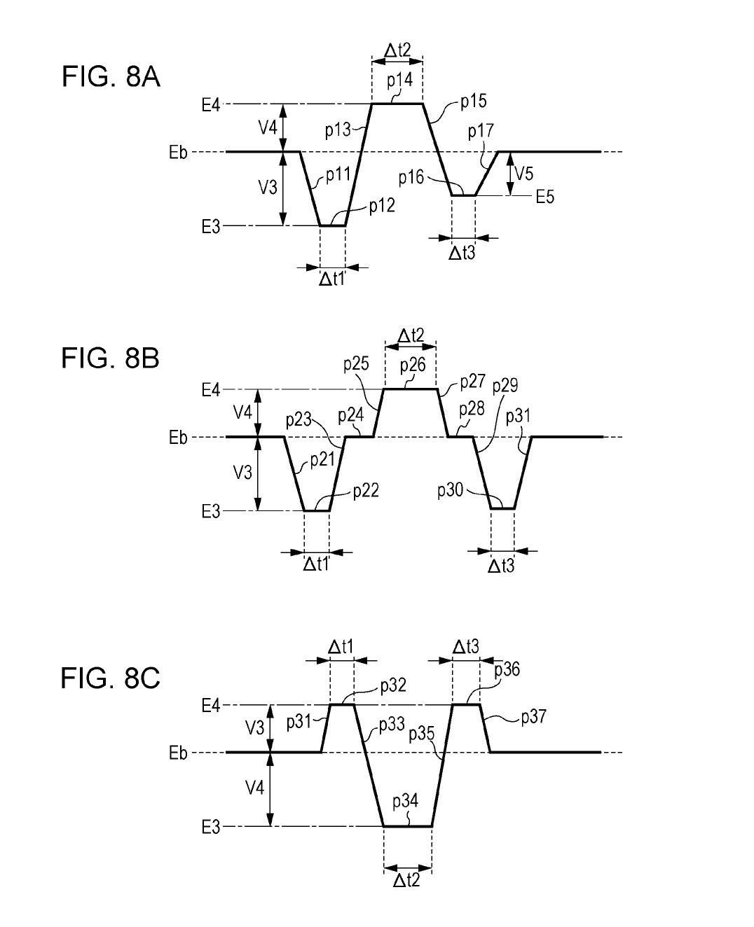

FIGS. 8A, 8B and 8C are waveform diagrams each for describing a modification example of a slight oscillation driving pulse.

In a slight oscillation driving pulse shown in FIG. 8A, V3, which is an electric-potential difference regarding a first trapezoidal-shaped waveform falling to the negative polarity side relative to the reference electric potential Eb, is different from V5 which, similarly, is an electric-potential difference regarding a second trapezoidal-shaped waveform falling to the negative polarity side relative to the reference electric potential Eb. That is, a termination electric potential of a second expansion element p15 and a termination electric potential of the slight oscillation expansion electric potential E3 are not necessary to be the same, provided that pressure oscillation excited by an expansion element p11 and pressure oscillation caused by a contraction element p13 can be set off therebetween. In this example, a termination electric-potential E5 of the second expansion element p15 is set to a value between the reference electric potential Eb and the slight oscillation expansion electric potential E3. In addition, configurations other than these configurations are the same as those of the above first embodiment. In this way, the termination electric current E5 corresponding to the third electric potential can be appropriately set, and thus, it comes possible to effectively improve a capability of suppressing the behavior of the meniscus after the completion of the slight oscillation operation. That is, it becomes possible to, through setting of the termination electric potential E5 to an appropriate value, cause the second expansion element p15 and a return element p17 to suppress the excitation of larger oscillation than needed, and at the same time, suppress the meniscus oscillation. Accordingly, it is possible to keep the ejection stability in a subsequent ejection operation with further certainty.

Further, a slight oscillation driving pulse shown in FIG. 8B has a characteristic in that a waveform element corresponding to the second variation element in any one of the aspects of the invention is configured so as to form a plurality of stages (two stages), and similarly, a waveform element corresponding to the third variation element in any one of the aspects of the invention is configured so as to form a plurality of stages (two stages). More specifically, a waveform element corresponding to the second variation element is composed of a previous stage contraction element p23, a first intermediate hold element p24 and a subsequent stage contraction element p25. Further, a waveform element corresponding to the third variation element is composed of a previous stage contraction element p27, a second intermediate hold element p28 and a subsequent stage contraction element p29. In this way, through providing a hold element for holding an electric potential to a constant value in the middle of each of the second variation element and the third variation element, it is possible to, for example, set the subsequent stage contraction element p25 such that the subsequent stage contraction element p25 is applied to the piezoelectric element 18 at timing of activating oscillation having been excited by the previous stage contraction p23, and thus, it is possible to improve the agitation capability. Further, it is possible to set the subsequent stage contraction element p29 such that the subsequent stage contraction element p29 is applied to the piezoelectric element 18 at timing of suppressing oscillation having been excited by the previous stage expansion element p27, and thus, it is possible to improve the oscillation suppression capability. In addition, each of electric potentials of hold elements is not necessary to be the reference electric potential Eb. Further, configurations other than these configurations are the same as those of the above first embodiment.

Further, a slight oscillation driving pulse Pv shown in FIG. 8C is a pulse whose polarity is reverse to that of the slight oscillation driving pulse Pv of the first embodiment. In this case, the positive polarity corresponds to the first polarity in any one of the aspects of the invention, and the negative polarity corresponds to the second polarity in any one of the aspects of the invention. The waveform of this slight oscillation pulse can be employed in a configuration employing a so-called vertical oscillation type piezoelectric element as a pressure generation means.

Moreover, with respect to the slight oscillation driving pulse Pv in the above first embodiment and the slight oscillation driving pulse Pv in each of the modification examples, a magnitude relation between V3 and V4 is not limited to the exemplifications, and may be reversed.

Further, although, in the above first embodiment, there has been exemplified the configuration in which two ejection driving pulses PD and one slight oscillation driving pulse Pv are included, the invention is not limited to this configuration, and a configuration therefor is sufficient merely provided that at least one ejection driving pulse and at least one slight oscillation driving pulse are included in the driving signal COM. Further, although there has been exemplified the configuration in which any one of the ejection driving pulses Pd has the same waveform, it is possible to employ ejection driving pulses having various waveforms.

Moreover, although, in the above first embodiment, there has been exemplified a so-called slight oscillation inside a printing operation, in which slight oscillation is excited by a slight oscillation driving pulse during a recording operation (a printing operation) with respect to a nozzle which is in a state where no ink is to be ejected through the nozzle itself, the invention is not limited to this slight oscillation inside a printing operation, and the slight oscillation driving pulse according to the first embodiment can be also applied to a so-called slight oscillation outside a printing operation, in which the slight oscillation is continuously excited during a period when no printing operation is performed.

In addition, the invention can be applied to not only the printer, but also liquid ejecting apparatuses each capable of performing slight oscillation control using a slight oscillation pulse. That is, the invention can be also applied to various kinds of ink jet recording apparatus, such as a plotter, a facsimile machine and a copying machine, as well as liquid ejecting apparatuses other than the recording apparatuses, such as a display manufacturing apparatus, an electrode manufacturing apparatus and a chip manufacturing apparatus.

The entire disclosure of Japanese Patent Application No. 2012-241577, filed Nov. 1, 2012 is expressly incorporated by reference herein.

What is claimed is:

1. A liquid ejecting apparatus comprising:
a liquid ejection head that includes a nozzle through which liquid is ejected, a pressure chamber which communicates with the nozzle, and a pressure generation portion which causes liquid contained in the pressure chamber to be subjected to a pressure variation, and that causes liquid to be ejected through the nozzle by driving the pressure generation portion; and
a drive waveform generation portion that generates a slight oscillation waveform which does not cause liquid to be ejected through the nozzle,
wherein the slight oscillation waveform includes a first variation element which varies up to a first electric potential of a first polarity relative to a reference electric potential and thereby causes liquid contained in the pressure chamber to be subjected to a pressure variation, a second variation element which varies up to a second electric potential of a second polarity, which is different from the first polarity, relative to the reference electric potential and thereby causes liquid contained in the pressure chamber to be subjected to a pressure variation, a third variation element which varies up to a third electric potential of the first electric potential and thereby causes liquid contained in the pressure chamber to be subjected to a pressure variation, and a fourth variation element which varies up to the reference electric potential and thereby causes liquid contained in the pressure chamber to be subjected to a pressure variation.

2. A liquid ejecting apparatus comprising:
a liquid ejection head that includes a nozzle through which liquid is ejected, a pressure chamber which communicates with the nozzle, and a pressure generation portion which causes liquid contained in the pressure chamber to be subjected to a pressure variation, and that causes liquid to be ejected through the nozzle by driving the pressure generation portion; and
a drive waveform generation portion that generates a slight oscillation waveform which does not cause liquid to be ejected through the nozzle,
wherein the slight oscillation waveform includes a first variation element which varies from a reference electric potential up to a first electric potential of a first polarity relative to the reference electric potential and thereby causes liquid contained in the pressure chamber to be subjected to a pressure variation, a second variation element which varies from the first variation element up to a second electric potential of a second polarity, which is different from the first polarity, relative to the reference electric potential and thereby causes liquid contained in the pressure chamber to be subjected to a pressure variation, a third variation element which varies from the second variation element up to a third electric potential of the first electric potential and thereby causes liquid contained in the pressure chamber to be subjected to a pressure variation, and a fourth variation element which varies from the third variation element up to the reference electric potential and thereby causes liquid contained in the pressure chamber to be subjected to a pressure variation.

3. The liquid ejecting apparatus according to claim 1, wherein the first electric potential and the third electric potential are equal to each other.

4. The liquid ejecting apparatus according to claim 1, wherein the first electric potential and the third electric potential are different from each other.

5. The liquid ejecting apparatus according to claim 1, wherein the second variation element is applied to the pressure generation portion at timing of generating pressure oscillation capable of activating pressure oscillation which is excited caused inside liquid contained in the pressure chamber by the first variation element.

6. The liquid ejecting apparatus according to claim 1, wherein a period of time from a start of the second variation element to an end of the fourth variation element is equal to a period of time resulting from multiplying a natural oscillation cycle of liquid contained in the liquid chamber by a natural number.

7. A control method for controlling a liquid ejecting apparatus including a liquid ejection head that includes a nozzle through which liquid is ejected, a pressure chamber which communicates with the nozzle, and a pressure generation portion which causes liquid contained in the pressure chamber to be subjected to a pressure variation, and causes liquid to be ejected through the nozzle by driving the pressure generation portion, and a drive waveform generation portion which generates a slight oscillation waveform that does not cause liquid to be ejected through the nozzle, the control method comprising:
causing a slight oscillation operation to be performed by applying a slight oscillation waveform to the pressure generation portion, the slight oscillation waveform including a first variation element which varies up to a first electric potential of a first polarity relative to a reference electric potential and thereby causes liquid contained in the pressure chamber to be subjected to a pressure variation, a second variation element which varies up to a second electric potential of a second polarity, which is different from the first polarity, relative to the reference electric potential and thereby causes liquid contained in the pressure chamber to be subjected to a pressure variation, a third variation element which varies up to a third electric potential of the first electric potential and thereby causes liquid contained in the pressure chamber to be subjected to a pressure variation, and a fourth variation element which varies up to the reference electric potential and thereby causes liquid contained in the pressure chamber to be subjected to a pressure variation.
